(19) United States
(12) Patent Application Publication
(10) Pub. No.: US 2020/0118058 A1
(43) Pub. Date: Apr. 16, 2020

(54) REAL-TIME WORKFLOW TRACKING

(71) Applicant: Clean Claims IP, LLC, Bluffdale, UT (US)

(72) Inventor: Lane Larsen, Bluffdale, UT (US)

(73) Assignee: Clean Claims IP, LLC, Bluffdale, UT (US)

(21) Appl. No.: 16/653,396

(22) Filed: Oct. 15, 2019

Related U.S. Application Data
(60) Provisional application No. 62/745,580, filed on Oct. 15, 2018.

(51) Int. Cl. G06Q 10/06

(52) U.S. Cl. CPC G06Q 10/063114; G06Q 10/0633; G06Q 10/06313

(57) ABSTRACT

Systems, methods, and device for workflow tracking is provided. This includes initiating a project upon request and assigning tasks to the project. As the project is being completed, input is received from sensor or a processor concerning the assigned tasks. Finally, the sensory data input is stored, and a notification of a task completion is sent.

### PRIORITY CLAIMS

This application claims the benefit of U.S. Provisional Application No. 62/745,580, filed Oct. 15, 2018, which is incorporated herein by reference in its entirety, including but not limited to those portions that specifically appear hereinafter, the incorporation by reference being made with the following exception: In the event that any portion of the above-referenced provisional application is inconsistent with this application, this application supersedes said above-referenced provisional application.

### TECHNICAL FIELD

The disclosure relates generally to systems, methods, and devices for workflow tracking and particularly relates to computer implementations for real-time workflow task tracking.

### BACKGROUND

Various industries and business models utilize workflows for organizing tasks and tracking progress on various workflow tasks. In certain industries, workflows can be exceedingly complex and may include many tasks that may be impacted by various conditions. Further, in some industries, progress of workflow tasks is measured by numerous sensors that may be configured to automatically provide sensor data. A plurality of persons and entities may be interested in the progress of one or more of the workflow tasks and may benefit from receiving an automatic update on workflow progress in real-time.

Systems, methods, and devices disclosed herein provide automatic workflow tracking in real-time. Such workflow tracking systems may be in communication with one or more accounts, including for example, a provider account, a consumer account, and/or a third-party account. Additionally, one or more sensors may be in communication with a workflow tracking system to provide real-time updates on workflow tasks.

### SUMMARY

Disclosed herein is real-time workflow tracking method, system, and device. The method may include receiving a request to initiate a new project and assigning one or more tasks to the project. The method may further includes receiving by or one or more processors sensor input data associated with at least one of the plurality of tasks in the project. The method may further includes assigning the sensor input data to the task where the sensor input data satisfies one or more task completion requirements. The method may further include storing the sensor input data and transmitting a task completion notification in response to storing the sensor input data.

The real-time workflow tracking system includes a processor that receives a request to initiate a new project and assigns one or more tasks to the project. The processor may also receive sensor input data associated with at least one of the one or more tasks in the project. The system may also include a sensor which obtains sensor input data. The processor may associate the sensor input data with the task where the sensor input data satisfies one or more task completion requirements. The processor may further cause the sensor input data to be stored in a memory storage device and transmit a task completion notification in response to storing the sensor input data.

The device includes a camera and a processor. The processor receives a request to begin a project and then assigns at least one task to the project. Next, the processor assigns photographic data from the camera to a task. Finally, the processor takes the photographic data and stores the photographic data in a memory device and then sends out a task completion notification.

### BRIEF DESCRIPTION OF THE DRAWINGS

Non-limiting and non-exhaustive implementations of the present disclosure are described with reference to the following figures, wherein like reference numerals refer to like parts throughout the various views unless otherwise specified. Advantages of the present disclosure will become better understood with regard to the following description and accompanying drawings:

FIG. 1 illustrates a schematic diagram of a system for providing workflow tracking, according to an embodiment of the disclosure.

FIG. 2 illustrates a schematic diagram of a process flow for workflow tracking, according to an embodiment of the disclosure.

FIG. 3 illustrates a schematic diagram of a process flow for workflow tracking, according to an embodiment of the disclosure.

FIG. 4 illustrates a schematic diagram of a process flow for workflow tracking, according to an embodiment of the disclosure.

FIG. 5 illustrates a schematic diagram of a process flow for workflow tracking, according to an embodiment of the disclosure.

FIG. 6 illustrates a schematic diagram of a process flow for workflow tracking, according to an embodiment of the disclosure.

FIG. 7 illustrates a schematic diagram of a process flow for workflow tracking, according to an embodiment of the disclosure.

FIG. 8 illustrates an example computing system, according to an embodiment of the disclosure.

### DETAILED DESCRIPTION

The present disclosure extends to systems, methods, and devices for real-time workflow tracking. Workflow tracking is an important aspect of many industries and business models. Various industries, including service industries, manufacturing industries, professional industries, marketing industries, and so forth benefit from generating a workflow or project that has one or more workflow items or tasks. A workflow may be synonymous with a project and includes one or more workflow items or tasks that are steps toward execution of the project. For example, a workflow or project may be repairing flood damage and one or more tasks or workflow items may be assigned to repair the flood damage (e.g., remove wet drywall, clean, dry wet area, etc.). The workflow items or tasks may include for example, certain actions to be completed to complete the task, including, a threshold sensor reading to be reached, a communication or notification to be generated and transmitted, an agreement to be generated and signed, a threshold number of hours to be worked, and so forth. Communications generated may include one or more processors sending out project completion notifications upon storing one or more sensory input data associated with of one or more workflow items or tasks. A single provider may have a plurality of workflows or projects for each job that may be performed, and each of the plurality of workflows or project may have a different combination of workflow items or tasks. Such workflows or projects may be exceedingly complex and may include numerous workflow items or tasks. Further, numerous persons and/or entities may need to know the status of such workflow items or tasks, and the progress of the workflow or project may be measured by a multitude of sensors or other data.

The systems, methods, and devices disclosed herein provide for automatic real-time workflow or project tracking. Such systems, methods, and devices, include one or more processors, generate a workflow or project including one or more workflow items or tasks, wherein the one or more workflow items or tasks is determined based on an input and a predefined rule. Predefined may be synonymous to task completion requirement. For example, a predefined rule or task completion requirements for flood damage repair may include a before and after moisture testing, replacement of damaged drywall and damaged carpet, and before and after pictures. In an embodiment, a provider, such as a provider of goods or services, determines the predefined rule or task completion requirements and indicates which workflow items or tasks should be associated with certain inputs. Varying inputs that determine the workflow items or tasks may include, for example, job type, job location, job time, customer type, staffing data for the provider, financial data for the provider, and so forth. The workflow or project may be automatically generated by one or more processors based on various inputs including sensory input data associated with a task. Furthermore, the workflow or project, including the sensory input, may be associated with or assigned to one or more accounts or users to satisfy task completion requirements. Such accounts or users may be associated with, for example, a consumer, a third party, or a provider. In an embodiment, sensor data is provided automatically or manually and is stored in a storage medium, and such sensor data is analyzed to determine progress or completion of one or more workflow items or tasks. A message may be generated, in response to storing the sensory input data, that indicates the progress or completion of one or more workflow items or tasks, and the message may be automatically provided to one or more accounts in real-time.

Before the structure, systems, and methods for real-time workflow or project tracking are disclosed and described, it is to be understood that this disclosure is not limited to the particular structures, configurations, process steps, and materials disclosed herein as such structures, configurations, process steps, and materials may vary somewhat. It is also to be understood that the terminology employed herein is used for the purpose of describing particular embodiments only and is not intended to be limiting since the scope of the disclosure will be limited only by the appended claims and equivalents thereof.

In describing and claiming the subject matter of the disclosure, the following terminology will be used in accordance with the definitions set out below.

It must be noted that, as used in this specification and the appended claims, the singular forms “a,” “an,” and “the” include plural referents unless the context clearly dictates otherwise.

As used herein, the terms “comprising,” “including,” “containing,” “characterized by,” and grammatical equivalents thereof are inclusive or open-ended terms that do not exclude additional, unrecited elements or method steps.

As used herein, the phrase “consisting of” and grammatical equivalents thereof exclude any element or step not specified in the claim.

As used herein, the phrase “consisting essentially of” and grammatical equivalents thereof limit the scope of a claim to the specified materials or steps and those that do not materially affect the basic and novel characteristic or characteristics of the claimed disclosure.

In an embodiment, a method for workflow or project tracking includes generating a workflow or project including one or more workflow items or tasks, wherein the one or more workflow items or tasks are determined based on an input and a predefined rule or task completion requirements. The method includes providing one or more forms for one or more processors receiving data on the one or more workflow items or tasks. The method includes one or more processors determining sensor data that should be obtained to complete the task and assigning the user of the sensor with one or more of the workflow items or tasks. The method includes determining at least one of the one or more workflow items or task is complete based on the sensor data.

Reference will now be made in detail to the exemplary embodiments, examples of which are illustrated in the accompanying drawings. Wherever possible, the same reference numbers are used throughout the drawings to refer to the same or like parts. It is further noted that elements disclosed with respect to embodiments are not restricted to only those embodiments in which they are described. For example, an element described in reference to one embodiment or figure, may be alternatively included in another embodiment or figure regardless of whether or not those elements are shown or described in another embodiment or figure. In other words, elements in the figures may be interchangeable between various embodiments disclosed herein, whether shown or not.

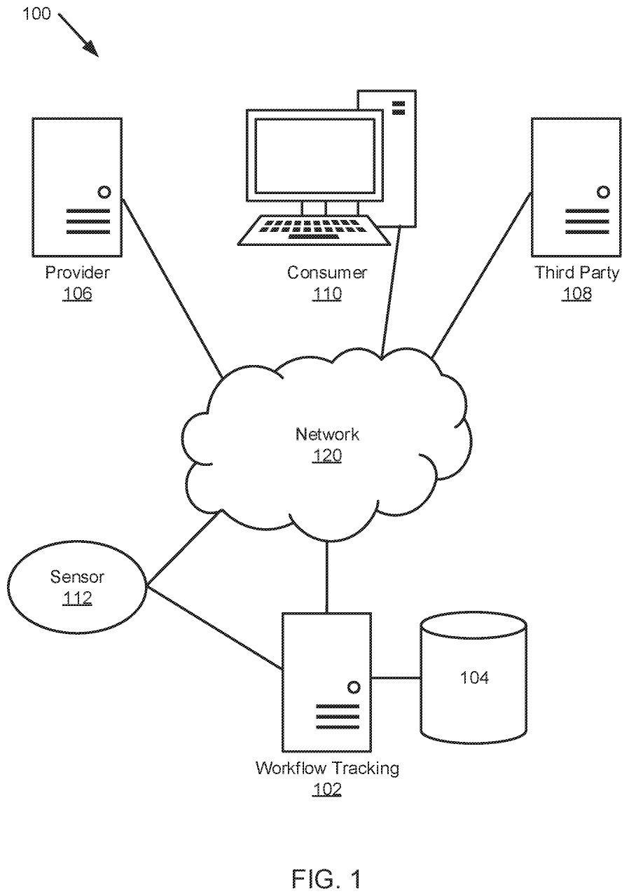

Referring now to the figures, FIG. 1 illustrates a schematic diagram of a system 100 for real-time workflow tracking. In an embodiment, the system 100 includes a workflow tracking platform 102 with an associated database 104. The database 104 is configured to store data relating to the workflow tracking platform 102, including data received from other sources, such as sensor data, and data relating to rules, settings, and intelligence sources for tracking workflow or projects. The workflow tracking platform 102 is in communication with a provider 106, a consumer 108, and a third party 110 over a network 120. The workflow tracking platform 102 is further in communication with one or more sensors 112.

The provider 106 is an account associated with a provider of goods and/or services. The person and/or entity associated with the provider 106 account may be, for example, an entity that provides goods or services, an employee, an independent contractor, a manager, an organization, a political platform, a retailer, a professional, a nonprofit organization, and so forth. The provider 106 may include a computing system and/or server in communication with the person or entity associated with the account. The provider 106 may communicate with the workflow tracking platform 102 over the network 120. The provider 106 may communicate inputs received from the person/entity associated with the account to the workflow tracking platform 102 and such inputs may be consumed and processed to provide dynamic and real-time tracking of a workflow process.

The consumer 110 is an account associated with a person and/or entity that is receiving a good or service from the person/entity associated with the provider 106. The consumer 110 may be a computing resource and/or server that is in communication with the workflow tracking platform 102 by way of the network 120 and receives inputs from a consumer person or entity by way of, for example, a web-based application, a mobile application, or any other electronic communication. The consumer 110 may provide information, updates, contracts, forms, and so forth to the person/entity associated with the consumer 110 account. Further, the consumer 110 may receive updates, for example, electronic signatures, form inputs, personal information, and so forth, from the person/entity associated with the consumer 110 account.

The third party 108 is an account associated with a person and/or entity that is a third party to a transaction occurring between the persons/entities associated with the provider 106 and consumer 110 accounts. In an embodiment, the third party 108 is a computing resource and/or server that is in communication with the workflow tracking platform 102 by way of the network 120 and receives inputs from a third-party person or entity by way of, for example, a web-based application, a mobile application, or any other electronic communication. In various embodiments, the third-party person/entity includes, for example, an insurance company, an administrative agency, a research organization, and so forth.

The sensor 112 may be any suitable sensor relevant to the workflow or project and may be in communication with the workflow tracking platform 102 directly or by way of a network 120 such as a cloud computing network. The sensor 112 may provide sensor data to the workflow tracking platform 102 that may be automatically analyzed, by one or more processor, and assessed to determine if one or more items in the workflow or project is complete or progressing. Then one or more processor may generate a progress report that may include an estimated time of completion. The sensor 112 data may be forwarded to one or more of the providers 106 account, the third-party 108 account, or the consumer 110 account by the workflow tracking platform 102. The sensor 112 data may be stored in the database 104 long-term such that it is categorized (e.g., associated with a particular task) and may be analyzed and retrieved even after a workflow or project or task is closed.

For example, in an implementation where the workflow or project concerns a flood repair service, the sensor 112 may include a moisture sensor that provides a reading on the current state of moisture at a location. Further, the sensor 112 may include a camera that may automatically or manually capture images of a location producing picture data. Additionally, the sensor 112 may produce data that is stored in a non-transitory readable storage medium and a task completion notification may be sent out in response to storing the sensory input data. The sensor 112 may further include a reading from one or more pieces of equipment indicating, for example, whether the equipment is functioning properly, how long the equipment has been utilized, an estimated lifetime for the equipment, whether the equipment requires additional fuel, and so forth.

It should be appreciated the workflow or project may be directed to any suitable industry, including any suitable service-based industry. Various workflows or projects may have different workflow items or tasks relevant to the particular job and/or industry. Further, various sensors are applicable to varying industries and it should be appreciated that any suitable sensor may be utilized in accordance with the present disclosure.

The workflow tracking platform 102 is in communication with the provider 106, the third party 108, and the consumer 110 by way of the network 120. The workflow tracking platform 102, in one embodiment, is a web-based application and/or a mobile device application. In an embodiment, the workflow tracking platform 102 is cloud-based and may be accessed by any of the provider 106, the third party 108, and/or the consumer 110 at any given time. The workflow tracking platform 102 serves to provide dynamic and real-time information concerning a workflow for a good, service, marketing campaign, or other product.

The workflow tracking platform 102 may automatically generate a workflow or project and auto populate the workflow or project with one or more workflow items or tasks. Workflow items or tasks include, for example, a task to be completed, a sensor reading to be determined, a workorder agreement to be generated, a workorder agreement to be signed, a threshold sensor reading to be reached, a threshold time of working to be reached, a final product to be generated or provided, and so forth. In various embodiments the workflow items or tasks may be manually input by a user associated with any of the provider 106, the third party 108, or the consumer 110. Further, the workflow items or tasks may be automatically generated according to predefined rules or task completion requirements set by, for example, the provider 106. Further, the workflow items or tasks may be automatically generated according to one or more inputs received from an account. For example, an account may indicate to the workflow tracking platform 102 that a workflow or projects should be generated for a particular job type. The workflow tracking platform 102 may then automatically generate one or more workflow items or tasks to be completed according to predefined rules or task completion requirements for that particular job type.

The workflow tracking platform 102 utilizes inputs received from any user including the provider 106, the third party 108, the consumer 110, and/or the sensor 112 to indicate a real-time status update for a workflow or project. In an embodiment, the workflow tracking platform 102 merges data, including sensor input data, received from the provider 106, the third party 108, and the consumer 110 to provide a comprehensive real-time status report for all of the relevant workflow or project. In an embodiment, the workflow tracking platform 102 does not receive data from every account associated with the workflow or project, (e.g. the provider 106, the consumer 110, and the third party 108) but permits all relevant accounts to view data relevant to the workflow or project. In an embodiment, the workflow tracking platform 102 generates individualized reports for different accounts. The individualized reports may provide certain data and hide other data from view for a particular account. In an embodiment, the workflow tracking platform 102 generates multiple reports for a single account (e.g. the provider 106, consumer 110, and/or third party 108) and each of the multiple reports is specialized for a particular user associated with that account. For example, a manager associated with the provider 106 account may have different permissions rules and may be permitted to view more information than an independent contractor associated with the provider 106 account.

The workflow tracking platform 102 may update data for one or more workflow items or tasks according to inputs received from any of the provider 106, the third party 108, the consumer 110, or the sensor 112. Further, the workflow tracking platform 102 may generate one or more messages to be transmitted based on any status update to the workflow or project. In an embodiment, the workflow tracking platform 102 automatically updates a consumer 110 account when a threshold sensor reading has been reached, for example. Further for example, the workflow tracking platform 102 automatically updates a management account associated with the provider 106 when, for example, an employee account associated with the provider 106 has checked in or begins working on a workflow item or task.

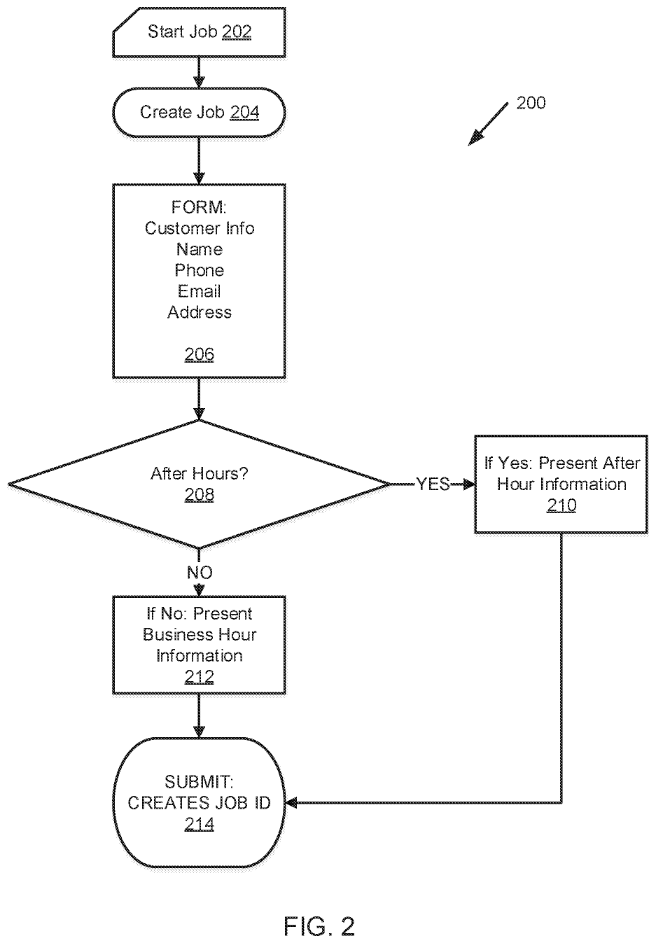

In a particular embodiment, the workflow tracking platform 102 particularly provides real-time workflow tracking for a flood repair service (although platform 102 could be used in connection with any project having a plurality of tasks) as particularly illustrated in the workflow diagrams as illustrated in FIGS. 2-7. It should be appreciated that the workflow tracking platform 102 may be applied to any suitable good, service, marketing campaign, and so forth, and is not restricted to the application of a flood repair service workflow.

FIG. 2 is a schematic block diagram of a process flow 200 for generating a job identification for a workflow or project. The process flow 200 as illustrated in FIG. 2 may be particularly applied to a workflow or project for repairing flood damage as an exemplary project with a plurality of tasks. However, it should be appreciated that the process flow 200 may be applied to any suitable workflow or project, including a workflow or project for any service or product. The process flow 200 may indicate inputs received from a person associated with an account such as the provider 106, the third party 108, or the consumer 110. Further, the process flow 200 may indicate inputs automatically generated by the provider 106, the third party 108, and/or the consumer 110 without intervention or interaction from a person. The process flow 200 depicted in FIG. 2 may be particularly associated with a provider 106 account.

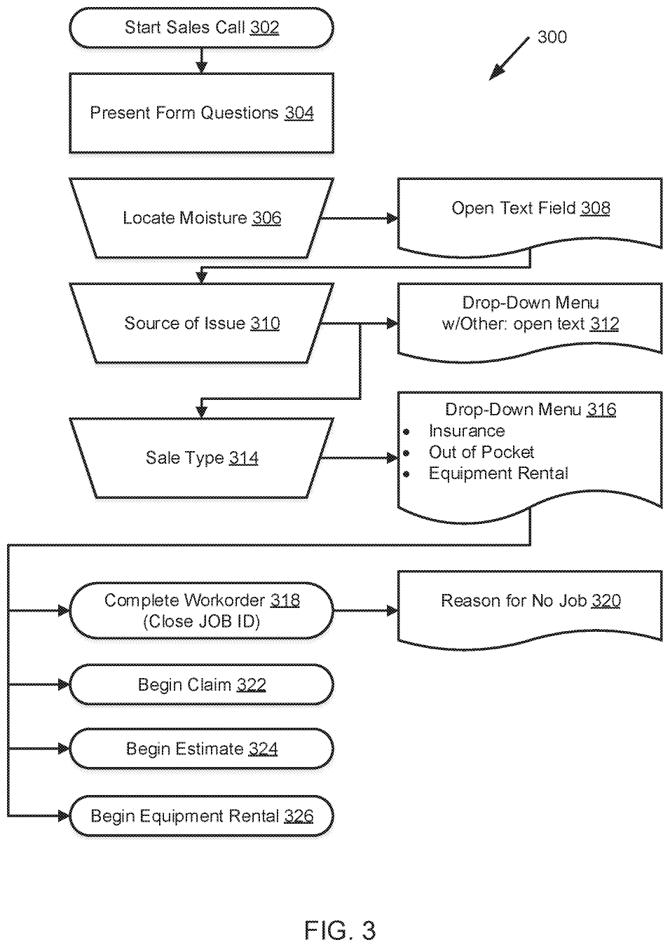

The process flow 200 begins and a job or project is initiated at 202. An input is received or generated to create the job or project at 204. In an embodiment, the workflow tracking platform 102 provides a form at 206 that includes, for example, requests for customer information, name, phone number, email address, mailing address, and so forth. The workflow tracking platform 102 queries whether the job or project is performed after hours at 208. If the workflow tracking platform 102 receives an indication that the job or project is performed after hours, the workflow tracking platform 102 will present after hour information at 210 and then create a job identification at 214. If the workflow tracking platform 102 receives an indication that the job or project is not performed after hours, the workflow tracking platform 102 will present business hour information at 212 and generate a job identification at 214. The workflow tracking platform 102 may then automatically transition into the process flow 300 illustrated in FIG. 3.

FIG. 3 illustrates a process flow 300 that may be particularly applied to a sales call in an exemplary flood repair service industry. It should be appreciated the process flow 300 may be applied to any suitable workflow or project associated with a service, product, and so forth. The process flow 300 begins and a sales call is initiated at 302. In an embodiment, the sales call is initiated at 302 automatically based on, for example, the generation of a job identification at 214, a phone call received from a consumer, an electronic communication received from a consumer, an input received from a consumer 110 that may be transmitted directly to the workflow tracking platform 102, and so forth. The workflow tracking platform 102 may present form questions at 304. Such form questions may include, for example, a request to locate moisture 306, a request to input a source of issue 310, and/or a request to input a sale type 314. As illustrated in FIG. 3, the workflow tracking platform 102 may present varying forms based on received inputs. For example, the workflow tracking platform 102 may present a form with an open text field at 308 to receive an open text response indicating where the moisture is located. Further, a drop-down menu with an option to input open text may be provided at 312 for receiving an input indicating the source of the issue. Further, a drop-down menu including, for example, options for insurance, out-of-pocket, and equipment rental may be presented at 316 for receiving an input as to the type of sale.

The process flow 300 continues and, in response to the input received at 316, the workflow tracking platform 102 may continue to one or more options. The workflow tracking platform 102 may complete the workorder at 318 by closing the job identification and may further indicate a reason there is no job or project at 320. The workflow tracking platform 102 may begin an insurance claim at 322, begin an estimate at 324, and/or begin an equipment rental at 326.

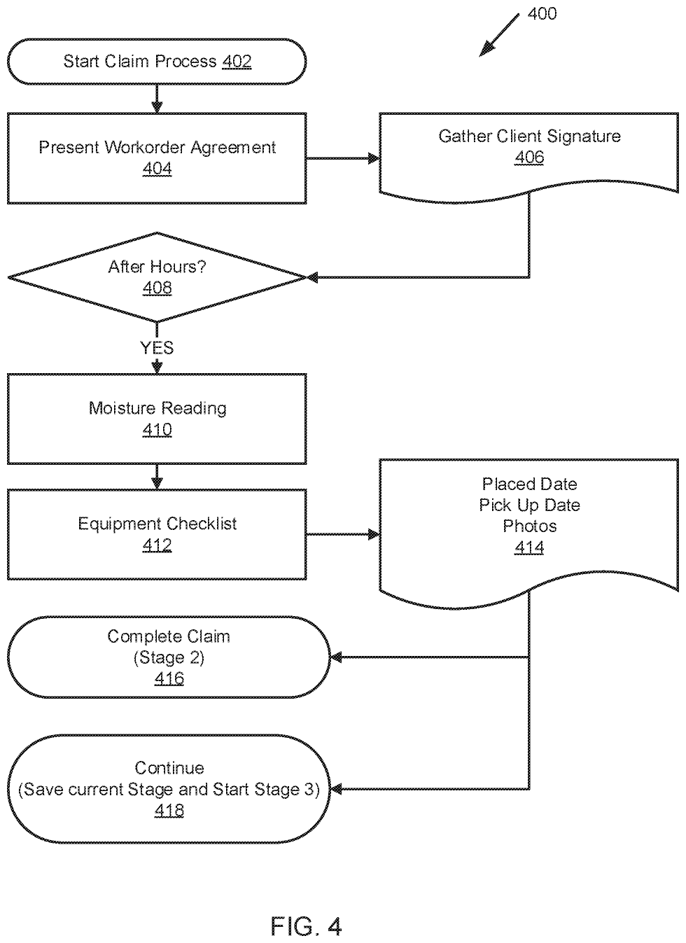

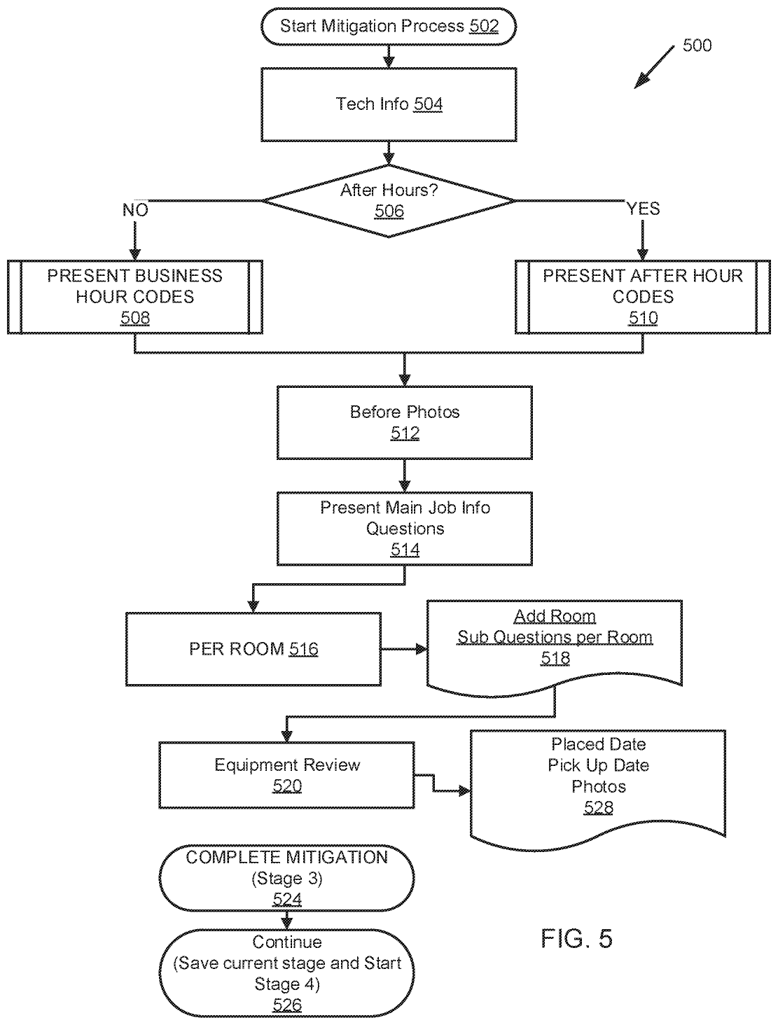

FIG. 4 illustrates a process flow 400 for initiating a claim. The process flow 400 may be particularly applied to a workflow or project for a flood repair service, but it should be appreciated that it may be applied to any suitable workflow or project with one or more suitable modifications. The process flow 400 may begin in response to the workflow tracking platform 102 initiating a claim at 322. The process flow 400 begins and the workflow tracking platform 102 begins the claim process at 402 and presents a workorder agreement at 404. The workorder agreement 404 may be accessed by the provider 106 and/or the consumer 110. In an embodiment, the provider 106 account may be accessed on a mobile device, for example, and physically presented to a consumer party for signature. In an embodiment, the consumer 110 account may be accessed by a consumer party such that the consumer party may input a signature on any suitable computing device at any time. The client signature may be received at 406 by the workflow tracking platform 102. The workflow tracking platform 102 may present an inquiry whether the claim is being processed after hours at 408. If the workflow tracking platform 102 receives an input indicating the claim is not initiated after hours, the process flow 400 may continue with the process flow 500 illustrated in FIG. 5. If the workflow tracking platform 102 receives an input indicating the claim is initiated after hours, the workflow tracking platform 102 may receive a moisture reading at 410 and/or an equipment checklist at 412. In response to receiving an input at 412 indicating what equipment is necessary, the workflow tracking platform 102 may present a form requesting inputs for a placed date, pick up date, and/or photos at 414. The process flow 400 may continue and the workflow tracking platform 102 completes the claim (stage two) at 416 and/or continues by saving the current stage and beginning stage three at 418.

FIG. 5 illustrates a process flow 500 for mitigation of a workflow or a project. The process flow 500 may be initiated in response to the workflow tracking platform 102 receiving an indication at 408 that a claim is initiated after hours. The mitigation process is initiated at 502 and technician information is received at 504. The workflow tracking platform 102 presents an inquiry at 506 whether the technician is operating after hours.

If the workflow tracking platform 102 receives an indication the technician is working after hours, the workflow tracking platform 102 presents after hour codes at 510. If the workflow tracking platform 102 receives an indication the technician is not working after hours, the workflow tracking platform 102 presents business hour codes at 508. The after-hour codes and the business hour codes may include, for example, different job types, different pricing, and so forth. The workflow tracking platform 102 receives before photos at 512 and receives response to main job information questions at 514 and may further receive at 516 such information for several scenarios or locations such as for reach room of a flooded location, and so forth. The workflow tracking platform 102 may provide sub questions at 518 for each of the different scenarios or locations, or particularly in the implementation illustrated in FIG. 5, for each room. The workflow tracking platform 102 provides at 520 a review of required equipment and may provide a form at 528 to receive verification and/or input on details for the equipment, such as placed date, pick-up date photos and so forth. The workflow tracking platform 102 may complete mitigation at stage three at 524 or may continue at 526 by saving the current stage and beginning stage four.

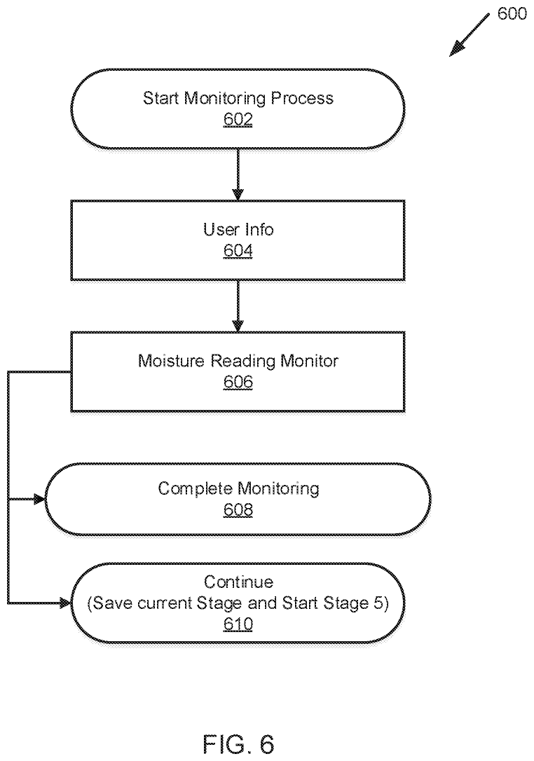

FIG. 6 illustrates a schematic block diagram of a process flow 600 for monitoring a workflow or a project. The process flow 600 may particularly be initiated in response to continuing at 526, where continuing may be manually inputted by a person/entity or may be automatically initiated by the workflow tracking platform 102. The process flow 600 begins and a monitoring process is initiated at 602. The monitoring process may be initiated automatically or after receiving an input from a user. The workflow tracking platform 102 collects user information at 604. Such user information may include, for example, employee or technician information for a user associated with the provider 106 account. The process flow 600 continues and moisture reading monitor information is determined at 606. Such information may be manually input by a user or may be received electronically from a monitor. It should be appreciated that in various implementations of the disclosure, the workflow tracking platform 102 may determine any suitable information and is not limited to receiving information directed to a moisture reading. The process flow 600 continues and monitoring is completed at 608. The workflow tracking platform 102 may continue at 610 by saving the current stage and beginning stage five.

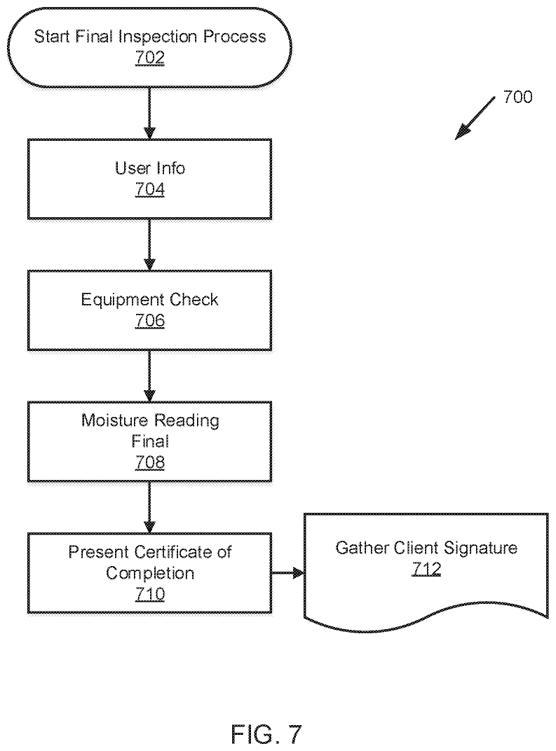

FIG. 7 illustrates a schematic block diagram of a process 700 for a final inspection phase in a workflow or a project. The process flow 700 illustrated in FIG. 7 is particularly directed to an implementation of monitoring repair of flooding damage, as in FIGS. 2-6. However, it should be appreciated that the process flows illustrated in FIGS. 2-7 may be directed to any suitable workflow, project, or implementation of the disclosure. The process flow 700 begins and a final inspection process is initiated at 702. User information is determined at 704, and such user information may include, for example, personal information on an employee or technician associated with a provider 106 account, including GPS location information for the employee or technician throughout each phase of the workflow or project process described herein. Equipment check data is determined at 706 and a final moisture reading is determined at 708. The moisture data may satisfy one or more task completion requirements. Such information may be received from a user input or it may be received electronically from a monitor in communication with the workflow tracking platform 102. The process flow 700 continues and the workflow tracking platform 102 present a certificate/notification of completion at 710 and presents a form at 712 for gathering a client signature.

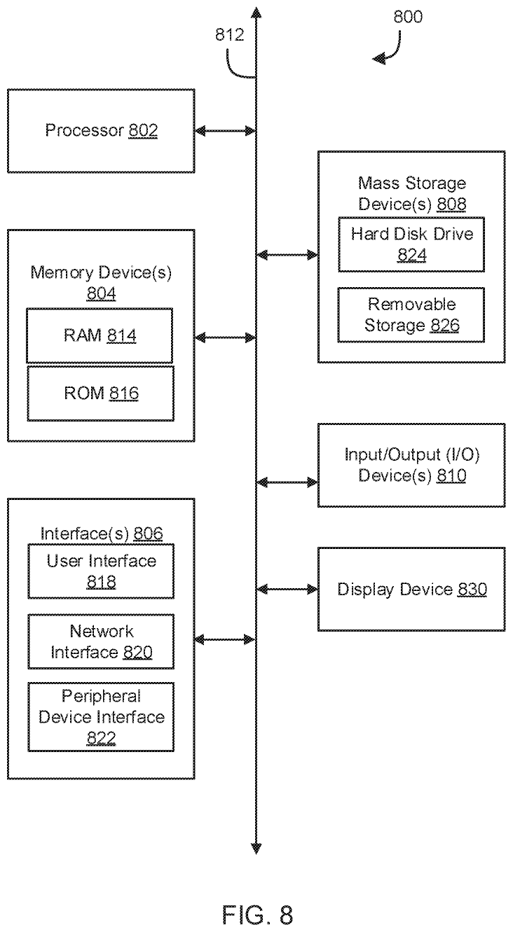

Referring now to FIG. 8, a block diagram of an example computing device 800 is illustrated. Computing device 800 may be used to perform various procedures, such as those discussed herein. In one embodiment, the computing device 800 may be implemented as a device associated with provider 106, a consumer 110, a third party 108, or a workflow tracking platform 102. Computing device 800 can perform various monitoring functions as discussed herein, and can execute one or more application programs, such as the application programs or functionality described herein. Computing device 800 can be any of a wide variety of computing devices, such as a desktop computer, in-dash computer, vehicle control system, a notebook computer, a server computer, a handheld computer, tablet computer, smart television, and the like.

Computing device 800 includes one or more processor(s) 802, one or more memory device(s) 804, one or more interface(s) 806, one or more mass storage device(s) 808, one or more Input/output (I/O) device(s) 810, and a display device 830 all of which are coupled to a bus 812. Processor(s) 802 include one or more processors or controllers that execute instructions stored in memory device(s) 804 and/or mass storage device(s) 808. Processor(s) 802 may also include various types of computer-readable media, such as cache memory.

Memory device(s) 804 include various computer-readable media, such as volatile memory (e.g., random access memory (RAM) 814) and/or nonvolatile memory (e.g., read-only memory (ROM) 816). Memory device(s) 804 may also include rewritable ROM, such as Flash memory.

Mass storage device(s) 808 include various computer readable media, such as magnetic tapes, magnetic disks, optical disks, solid-state memory (e.g., Flash memory), and so forth. Various drives may also be included in mass storage device(s) 808 to enable reading from and/or writing to the various computer readable media. Mass storage device(s) 808 include removable media 1226 and/or non-removable media.

I/O device(s) 810 include various devices that allow data and/or other information to be input to or retrieved from computing device 800. Example I/O device(s) 810 include cursor control devices, keyboards, keypads, microphones, monitors or other display devices, speakers, cameras, moisture devices, sensors, printers, network interface cards, modems, wireless or wired remote control devices, and the like.

Display device 830 includes any type of device capable of displaying information to one or more users of computing device 800. Examples of display device 830 include a monitor, display terminal, video projection device, and the like.

Interface(s) 806 include various interfaces that allow computing device 800 to interact with other systems, devices, including cameras, moisture devices and other sensors, or computing environments. Example interface(s) 806 may include any number of different network interfaces 820, such as interfaces to local area networks (LANs), wide area networks (WANs), wireless networks, and the Internet. Other interface(s) include user interface 818 and peripheral device interface 822. The interface(s) 806 may also include one or more user interface elements 818. The interface(s) 806 may also include one or more peripheral interfaces such as interfaces for printers, pointing devices (mice, track pad, or any suitable user interface now known to those of ordinary skill in the field, or later discovered), keyboards, and the like.

Bus 812 allows processor(s) 802, memory device(s) 804, interface(s) 806, mass storage device(s) 808, and I/O device(s) 810 to communicate with one another, as well as other devices or components coupled to bus 812. Bus 812 represents one or more of several types of bus structures, such as a system bus, PCI bus, IEEE bus, USB bus, and so forth.

For purposes of illustration, programs and other executable program components are shown herein as discrete blocks, although it is understood that such programs and components may reside at various times in different storage components of computing device 800 and are executed by processor(s) 802. Alternatively, the systems and procedures described herein can be implemented in hardware, or a combination of hardware, software, and/or firmware. For example, one or more application specific integrated circuits (ASICs) can be programmed to carry out one or more of the systems and procedures described herein.

### EXAMPLES

The following examples pertain to further embodiments.

Example 1 is a method of workflow tracking. The method includes generating a workflow or project including one or more workflow items or task, wherein the one or more workflow items are determined based on an input and a predefined rule or task completion requirements. The method includes providing one or more forms for receiving data on the one more workflow items or tasks. The method includes determining sensor data and assigning the sensor data with one or more of the workflow items or tasks. The method includes determining at least one of the one or more workflow items or tasks is complete based on the sensor data.

Example 2 is a method as in Example 1, wherein the one or more workflow items or tasks include one or more of a task, a threshold metric, an equipment rental, a client agreement, or a billing process.

Example 3 is a method as in any of Examples 1-2, wherein the one or more forms includes one or more of an open text field or a drop-down menu.

Example 4 is a method as in any of Examples 1-3, further comprising providing the workorder agreement to a consumer account with a request for a client signature.

Example 5 is a method as in any of Examples 1-4, further comprising providing the workorder agreement to a third-party account.

Example 6 is a method as in any of Examples 1-5, further comprising receiving an electronic signature for the workorder from one or more of a provider account, a third-party account, or a consumer account.

Example 7 is a method as in any of Examples 1-6, wherein generating the workflow or project comprises automatically generating the workflow or project based on an input and updating the workflow or project in real-time based on updated data received from one or more of: a provider account, a third-party account, a consumer account, or a sensor.

Example 8 is a method as in any of Examples 1-7, further comprising closing the workflow or project when a threshold number of the one or more workflow items or tasks is complete.

Example 9 is a method as in any of Examples 1-8, further comprising generating a workorder agreement based on the one or more workflow items or tasks and providing the workorder agreement to a provider account.

In the above disclosure, reference has been made to the accompanying drawings, which form a part hereof, and in which is shown by way of illustration specific implementations in which the disclosure may be practiced. It is understood that other implementations may be utilized, and structural changes may be made without departing from the scope of the present disclosure. References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

Implementations of the systems, devices, and methods disclosed herein may comprise or utilize a special purpose or general-purpose computer including computer hardware, such as, for example, one or more processors and system memory, as discussed herein. Implementations within the scope of the present disclosure may also include physical and other computer-readable media for carrying or storing computer-executable instructions and/or data structures. Such computer-readable media can be any available media that can be accessed by a general purpose or special purpose computer system. Computer-readable media that store computer-executable instructions are computer storage media (devices). Computer-readable media that carry computer-executable instructions are transmission media. Thus, by way of example, and not limitation, implementations of the disclosure can comprise at least two distinctly different kinds of computer-readable media: computer storage media (devices) and transmission media.

Computer storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium, which can be used to store desired program code means in the form of computer-executable instructions or data structures and which can be accessed by a general purpose or special purpose computer.

An implementation of the devices, systems, and methods disclosed herein may communicate over a computer network. A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links, which can be used to carry desired program code means in the form of computer-executable instructions or data structures and which can be accessed by a general purpose or special purpose computer. Combinations of the above should also be included within the scope of computer-readable media.

Computer-executable instructions comprise, for example, instructions and data which, when executed at a processor, cause a general-purpose computer, special purpose computer, or special purpose processing device to perform a certain function or group of functions. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the disclosure may be practiced in network computing environments with many types of computer system configurations, including, an in-dash vehicle computer, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, various storage devices, televisions, and the like. The disclosure may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Further, where appropriate, functions described herein can be performed in one or more of: hardware, software, firmware, digital components, or analog components. For example, one or more application specific integrated circuits (ASICs) can be programmed to carry out one or more of the systems and procedures described herein. Certain terms are used throughout the description and claims to refer to particular system components. The terms “modules” and “components” are used in the names of certain components to reflect their implementation independence in software, hardware, circuitry, sensors, or the like. As one skilled in the art will appreciate, components may be referred to by different names. This document does not intend to distinguish between components that differ in name, but not function.

It should be noted that the sensor embodiments discussed above may comprise computer hardware, software, firmware, or any combination thereof to perform at least a portion of their functions. For example, a sensor may include computer code configured to be executed in one or more processors and may include hardware logic/electrical circuitry controlled by the computer code. These example devices are provided herein purposes of illustration and are not intended to be limiting. Embodiments of the present disclosure may be implemented in further types of devices, as would be known to persons skilled in the relevant art(s).

At least some embodiments of the disclosure have been directed to computer program products comprising such logic (e.g., in the form of software) stored on any computer useable medium. Such software, when executed in one or more data processing devices, causes a device to operate as described herein.

While various embodiments of the present disclosure have been described above, it should be understood that they have been presented by way of example only, and not limitation. It will be apparent to persons skilled in the relevant art that various changes in form and detail can be made therein without departing from the spirit and scope of the disclosure. Thus, the breadth and scope of the present disclosure should not be limited by any of the above-described exemplary embodiments but should be defined only in accordance with the following claims and their equivalents. The foregoing description has been presented for the purposes of illustration and description. It is not intended to be exhaustive or to limit the disclosure to the precise form disclosed. Many modifications and variations are possible in light of the above teaching. Further, it should be noted that any or all of the aforementioned alternate implementations may be used in any combination desired to form additional hybrid implementations of the disclosure.

Further, although specific implementations of the disclosure have been described and illustrated, the disclosure is not to be limited to the specific forms or arrangements of parts so described and illustrated. The scope of the disclosure is to be defined by the claims appended hereto, any future claims submitted here and in different applications, and their equivalents.

What is claimed is:

1. A non-transitory computer readable storage medium containing instructions which when executed by a processor cause the processor to perform a method, the method comprising:
receiving, by one or more processors, a request to initiate a new project;
assigning, by the one or more processors, one or more tasks to the project;
receiving, by the one or more processors, sensor input data associated with at least one of the plurality of tasks in the project;
assigning, by the one or more processors, the sensor input data to the task, the sensor input data satisfying one or more task completion requirements;
storing, by the one or more processors, the sensor input data, in the non-transitory computer readable storage medium; and
transmitting, by the one or more processors, in response to storing the sensor input data, a task completion notification.

2. The non-transitory computer readable storage medium of claim 1, the method further comprising:
receiving, by one or more processors, sensor input data associated with a second task associated with the project;
storing, by the one or more processors, the sensor input data associated with the second task, in a storage medium; and
transmitting, by the one or more processors, in response to storing the sensory input data, a second task completion notification.

3. The non-transitory computer readable storage medium of claim 2, the method further comprising:
transmitting, by the one or more processors, in response to the second task completion notification, a project completion notification.

4. The non-transitory computer readable storage medium of claim 1, the method further comprising:
transmitting, by one or more processors, in response to the transmission of the task completion notification, a project completion notification.

5. The non-transitory computer readable storage medium of claim 1, wherein the sensor input data is picture data.

6. The non-transitory computer readable storage medium of claim 1, the method further comprising:
assigning, by the one or more processors, the task associated with the project to one or more users who operate the sensor.

7. The non-transitory computer readable storage medium of claim 1, the method further comprising:
generating, by the one or more processors, a progress report of the one or more of tasks associated with the project.

8. The non-transitory computer readable storage medium of claim 1, the method further comprising:
generating, by the one or more processors, an estimated time of completion of a project based on task completion at a time the estimated time of completion is requested by a user.

9. A digital workflow database tracking system comprising:
a processor to:
receive a request to initiate a new project;
assign a one or more tasks to the project;
receive sensor input data associated with at least one of the one or more tasks in the project;
a sensor obtaining the sensor input data;
wherein the processor associates the sensor input data obtained by the sensor with the task, the sensor input data satisfying one or more task completion requirements;
wherein the processor stores the sensor input data, in a memory storage device; and
wherein the processor transmits, in response to storing the sensor input data in the memory storage device, a task completion notification.

10. The system of claim 9, wherein the processor receiving the sensory input data is configured to receive photographic sensory input data.

11. The system of claim 9, wherein the processor automatically populates sensory input data into a task completion record.

12. The system of claim 11, wherein the processor assigns the task associated with the project to one or more users who operate the sensor.

13. The system of claim 9, wherein the processor receives input from another sensor.

14. The system of claim 9, wherein the processor transmits and receives sensor input data from two or more sensors.

15. The system of claim 9, wherein the processor task completion notification is transmitted by the processor to a user device.

16. The system of claim 9, wherein the stored sensor input data is stored as categorized information based on information collected concerning an individual project.

17. The system of claim 9, wherein to the stored sensor input data is stored as categorized information based on information collected concerning an individual task.

18. The system of claim 14, wherein the stored sensor input data is stored to categorize input based from which sensor from which the sensor input data was received.

19. A digital workflow database tracking device comprising:
a camera;
a processor configured to:
receive a request to initiate a project;
assign one or more tasks to the project; and
receive photographic data from the camera and associate photographic data from the camera with at least one of the one or more tasks in the project;
wherein the processor assigns photographic data from the camera to the task, the photographic data satisfying one or more task completion requirements;
wherein the processor stores the photographic data, in a memory storage device; and
wherein the processor transmits, in response to storing the photographic data in the memory storage device, a task completion notification.

20. The device of claim 19, wherein the device further receives moisture data from a moisture sensor and, in response to receiving the moisture data from the moisture sensor, associates the moisture data with the task, the moisture data satisfying one or more task completion requirements.
